(19) United States
(12) Patent Application Publication
(10) Pub. No.: US 2011/0109473 A1
(43) Pub. Date: May 12, 2011

(54) INSTRUMENT PANEL IMAGE DISPLAY DEVICE, INSTRUMENT PANEL IMAGE CHANGING METHOD, VEHICLE, SERVER, INSTRUMENT PANEL IMAGE CHANGING SYSTEM, INSTRUMENT PANEL IMAGE DISPLAY PROGRAM, COMPUTER READABLE RECORDING MEDIUM ON WHICH INSTRUMENT PANEL IMAGE DISPLAY PROGRAM IS RECORDED

(75) Inventors: Fumiaki Fujimoto, Osaka-shi (JP); Teruhisa Masui, Osaka-shi (JP); Kazuhiko Yoda, Osaka-shi (JP); Osamu Nishida, Osaka-shi (JP); Jun Hamachi, Osaka-shi (JP); Masayuki Fujisawa, Osaka-shi (JP)

(73) Assignee: SHARP KABUSHIKI KAISHA, Osaka-shi, Osaka (JP)

(21) Appl. No.: 12/674,208

(22) PCT Filed: Aug. 7, 2008
(86) PCT No.: PCT/JP2008/064255

§ 371 Date: Feb. 19, 2010

(30) Foreign Application Priority Data
Sep. 11, 2007 (JP) 2007-235959

(51) Int. Cl. G08G 1/00

(52) U.S. Cl. 340/901

(57) ABSTRACT

An instrument panel image display apparatus for displaying an instrument panel image on an instrument panel mounted on a machine includes an image display section arranged to display, in accordance with image data encoding instrument images that provide a user with information about an inside and an outside of the machine, an instrument panel image containing the instrument images, and an image data changing section arranged to change a display state of an instrument image to another display state according to a state of the machine, from among a plurality of display states determined in advance according to the state of the machine. With this structure, an instrument panel image according to the user's own preferences and the state of the machine is created without undermining safety during operation.

### BACKGROUND OF THE INVENTION

1. Field of the Invention

The present invention relates to an instrument panel image display apparatus, an instrument panel image changing method, a vehicle, a server, an instrument panel image changing system, an instrument panel image display program, a computer-readable storage medium containing an instrument panel image display program, each of which makes it possible to change from displaying one instrument panel image to displaying another.

2. Description of the Related Art

In recent years, an instrument panel that is mounted on a vehicle (machine) such as an automobile has been realized by displaying an instrument panel image on a display such as a liquid crystal display. Such a display shows an instrument panel image composed of images of various instruments such as a speedometer, a tachometer, and a fuel gauge.

However, a conventional instrument panel has had such a problem that a user cannot change from displaying one instrument panel images to displaying another.

As a technology to overcome this problem, Japanese Patent Application Publication, Tokukaihei, No. 10-297318 A discloses an instrument panel image selecting apparatus having (i) memory means in which to store plural pieces of instrument panel image data, (ii) selecting means for selecting, from among the plural pieces of instrument panel image data, instrument panel image data according to a selection operation, and for generating a selection signal thereof, and (iii) instrument panel image data output means for outputting, to the instrument panel image display means, the instrument panel image data selected according to the selection signal from among the plural pieces of instrument panel image data stored.

According to Japanese Patent Application Publication, Tokukaihei, No. 10-297318 A, use of the apparatus allows a user to select his/her favorite instrument panel image and display it on the instrument panel display means.

Incidentally, in general, the type and layout of an instrument panel image is limited by regulations such as JIS (Japanese Industrial Standards) out of consideration of the issue of safety during operation. However, a technique by which an instrument panel image according to a user's own preferences can be created as in Japanese Patent Application Publication, Tokukaihei, No. 10-297318 A makes it possible to create an instrument panel image as the user likes even in defiance of the regulations, thus posing a risk of undermining safety during operation.

In this regard, for example, Japanese Patent Application Publication, Tokukai, No. 2005-88673 A discloses a technology for making a judgment about the visibility of an instrument panel image of a user's choice and inhibiting deterioration in visibility. This makes it possible to create the user's favorite instrument panel image without undermining safety during operation.

However, the technology disclosed in Japanese Patent Application Publication, Tokukai, No. 2005-88673 A cannot be necessarily said to be safe or convenient for users. For example, the visibility of a displayed instrument panel to a user varies between a point of time where the user is driving a vehicle and at a point of time where the vehicle is at rest. In this regard, according to the technology, the range where safety is not undermined, i.e., the range where the visibility of an instrument image is uniformly set regardless of operation condition, and the user can freely set an instrument panel image within this range. Therefore, for example, even in cases where there is no problem with visibility while the vehicle is running at low speed, there is a danger of lower visibility while the vehicle is running at high speed. Thus, the technology gives no consideration to the state of a vehicle (machine) such as operation condition and puts more emphasis on the user's taste than on safety while driving, and as such, cannot be said to be sufficient in terms of safety.

Further, it is anticipated that laws, regulations, or the like intended to avoid undermining safety during operation will be developed along with the popularization of instrument panels capable of changing from displaying one image to displaying another. Such laws and regulations are classified into (i) fixed regulations and (ii) regulations that are amended as technology advances. For this reason, it is desirable that the instrument panel image display apparatus respond timely to amendments to laws and regulations.

### SUMMARY OF THE INVENTION

In view of the foregoing problems, preferred embodiments of the present invention provide an instrument panel image display apparatus, an instrument panel image changing method, a vehicle, a server, an instrument panel image changing system, an instrument panel image display program, a computer-readable storage medium containing an instrument panel image display program, each of which makes it possible to create an instrument panel image according to a user's own preferences and the state of a machine without undermining safety during operation.

An instrument panel image display apparatus according to a preferred embodiment of the present invention is an instrument panel image display apparatus for displaying an instrument panel image on an instrument panel mounted on a machine, including a display section arranged to display, in accordance with image data encoding instrument images that provide a user with information about an inside and an outside of the machine, an instrument panel image containing the instrument images; and image data changing section arranged to change a display state of an instrument image to another display state according to a state of the machine, the another display state being selected from among a plurality of display states determined in advance according to the state of the machine.

The present apparatus digitally displays an instrument panel image on an instrument panel, such as a liquid crystal display, which is mounted on a machine such as a vehicle.

Further, in the present apparatus, the instrument panel image that is displayed contains a plurality of instrument images, such as a speedometer image and a tachometer image, which provide the user with information about the inside and outside of the machine mounted therewith. Moreover, these instrument images are each encoded as image data. That is, in the present apparatus, the display section displays, on the instrument panel, individual instrument images encoded by plural pieces of image data, whereby a whole instrument panel image containing a plurality of instrument images is displayed on the instrument panel.

It should be noted here that, in the present apparatus, the image data changing section does not change the whole instrument panel image to another instrument panel image, but changes the display state of each separate image contained in the instrument panel image to another display state according to a state of the machine, the another display state being selected from among a plurality of display states determined in advance according to the state of the machine.

The term “state of the machine” encompasses: operation conditions, such as “rest”, “running at low speed”, “normal running”, “running at high speed”, “right turn”, “left turn”, and “reverse”, of a vehicle; and environmental conditions, such as “daytime”, “nighttime”, “sunny weather”, “rainy weather”, “warm weather”, and “cold weather”, surrounding the vehicle. Further, the terms “plurality of display states determined in advance” refers to a plurality of display states where safety is not undermined while ensuring the visibility of the instrument image and, for example, are set in advance with respect to the position, size, coloration, and the like of the instrument image in the instrument panel image. Such a display state reflects laws, regulations, or the like intended to ensure safety during operation, and can be changed as needed in accordance with an amendment to a law or the like. Therefore, the display state reflects not only fixed laws and regulations but also amended laws and regulations. Further, since the display state is set according to the state of the machine, for example, the display state is set in accordance with the operation condition of the vehicle within a proper range of laws and regulations, i.e., within a range where safety while driving is not undermined.

The configuration of the present apparatus makes it possible to improve visibility, for example, by displaying a speedometer image bigger while running at high speed than at low speed. Meanwhile, a change that reduces visibility, e.g., a change that displays a speedometer image smaller while running at high speed than at low speed is unacceptable, because such a change deviates from the range of display states determined in advance for use in running at high speed.

Further, the display state can be changed as needed in accordance with a law amendment or the like, and timely reflects laws, regulations, or the like intended to ensure safety during operation. Therefore, an instrument panel image can be displayed within a proper range of regulations.

Thus, in the present apparatus, the display state of each separate instrument image can be changed to another display state according a state of the machine, the another display state being selected from among a plurality of display states determined in advance according to the state of the machine. This brings about an effect of making it possible to create an instrument panel image according to a user's own preferences and the state of a machine without undermining safety during operation.

Further, an instrument panel image changing method according to another preferred embodiment of the present invention is an instrument panel image changing method for displaying an instrument panel image on an instrument panel mounted on a machine, including the steps of: (i) displaying, in accordance with image data encoding instrument images that provide a user with an information about inside and an outside of the machine, an instrument panel image containing the instrument images; and (ii) changing a display state of an instrument image to another display state according to a state of the machine, the another display state being selected from among a plurality of display states determined in advance according to the state of the machine.

With this configuration, the present method brings about the same effect as the aforementioned present apparatus.

Further, the instrument panel image display apparatus may preferably further include a parameter changing section arranged to change a parameter from one value to another, the parameter defining the display state of the instrument image.

With this configuration, in the present apparatus, an instrument image whose display state has been changed by a user to suit his/her own preferences can be displayed according to the state of a machine (e.g., vehicle) within a range of a plurality of predetermined display states. This brings about an effect of making it possible to increase a degree of freedom to which an instrument panel image to be displayed is selected, while ensuring safety during operation.

Further, the instrument panel image display apparatus may preferably further include a parameter judging section arranged to judge whether or not the parameter is taking on a value falling within a predetermined range.

With this configuration, the present apparatus discovers, in advance, that an instrument panel image contains an instrument image which, depending on the state of the machine, is displayed to the user improperly (e.g., in such a way that visibility is impaired). This brings about an effect of making it possible to prevent deterioration in safety during operation even when there is a change in state of the machine (e.g., from running at low speed to running at high speed).

Further, the instrument panel image display apparatus may preferably be configured such that, when the parameter judging section judges that the parameter as entered by an outside is not taking on a value falling within the predetermined range, the instrument panel image display apparatus prompts the outside to reenter the parameter.

Further, the instrument panel image display apparatus may preferably be configured such that, when the parameter judging section judges that the parameter is not taking on a value falling within the predetermined range, the parameter changing section changes the parameter to a value falling within the predetermined range.

With these configurations, the present apparatus restricts the parameter to the predetermined range so that that the parameter does not take on any value without any restriction. This brings about an effect of making it possible that an instrument image that is displayed to the user improperly (e.g., in such a way that visibility is impaired) is made to be displayed properly. For example, when the range of value that the parameter can take on is set in advance to such values that an instrument image can be seen by the user with clarity, an instrument image that is hard to see can be changed to such a state as to be seen with clarity.

Further, the instrument panel image display apparatus is may preferably be configured such that the parameter defines at least size and coloration of the instrument image.

With this configuration, the present apparatus brings about an effect of making it possible to change at least the size and coloration of the instrument image according to the state of the machine without undermining safety during operation.

Further, the instrument panel image display apparatus may preferably be configured such that the parameter further defines a position of the instrument image.

With this configuration, the present apparatus brings about an effect of making it possible to change the position of the instrument image within an instrument panel display surface according to the state of the machine without undermining safety during operation. This makes it possible, for example, to adjust the position of the instrument image according to the height of the user.

Further, the instrument panel image display apparatus may preferably further include an image data acquisition section arranged to acquire, through a network line from a server including a storage section, image data encoding the instrument image whose display state has been changed to the another display state, the storage section having the image data stored therein.

This configuration brings about an effect of making it possible, even in cases where image data encoding a selectable instrument image is newly provided, to easily acquire the data.

Further, a preferred embodiment of the present invention may be realized as a server-client system. In this case, the instrument panel image display apparatus and the server, which provides the apparatus with image data encoding the instrument image whose display state has been changed to the another display state, constitute an instrument panel image changing system.

A vehicle according to a preferred embodiment of the present invention preferably includes an instrument panel image display apparatus according to another preferred embodiment of the present invention described above. This configuration makes it possible to provide a vehicle mounted with an instrument panel image display apparatus with an increased degree of freedom to which an instrument panel image is changed.

The instrument panel image display apparatus may be realized by a computer. In this case, an instrument panel image display program for operating a computer as each of the means to realize such an instrument panel image display apparatus by computer and a computer-readable storage medium containing such an instrument panel image display program are encompassed in the scope of the present invention.

For a fuller understanding of the nature and advantages of the invention, reference should be made to the ensuing detailed description taken in conjunction with the accompanying drawings.

Other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating the configuration of an instrument panel image display apparatus according to one preferred embodiment of the present invention.

FIG. 2 illustrates the details of instrument image data, background image data, and thumbnail data in an image database.

FIG. 3 illustrates examples of types of parameter-regulating table stored in a regulating database.

FIG. 4 illustrates examples of correction values contained in a parameter-regulating table.

FIG. 5 is a flow chart showing the outline of an operation for changing an instrument image in the instrument panel image display apparatus.

FIG. 6 illustrates an example of arrangement of various instrument images within an instrument panel image.

FIG. 7 illustrates an instrument panel displaying a window that prompts a driver to select from among speedometer images for use in running at high speed.

FIGS. 8A and 8B illustrate an example where a speedometer image is corrected, wherein FIG. 8A illustrates an instrument panel image having a pre-correction image placed therein, and FIG. 8B illustrates an instrument panel image having a post-correction image placed therein.

FIG. 9 illustrates examples of ranges of areas that can be occupied by various instrument images that are arranged within an instrument panel image.

FIGS. 10A, 10B and 10C illustrate an example where the respective display states of various instrument images that are arranged within an instrument panel image are changed, wherein FIG. 10A illustrates an example of an instrument panel image right after a change, FIG. 10B illustrates ranges of areas where a navigator image and a speedometer image can be arranged within the instrument panel image, and FIG. 10C illustrates an instrument panel image having post-correction navigator and speedometer images arranged therein.

FIGS. 11A-11D illustrate an example where the display state of a speedometer image is corrected, wherein FIG. 11A illustrates a speedometer image whose display state has been neither adjusted nor corrected, FIG. 11B illustrating a speedometer image whose size has been changed, FIG. 11C illustrates an instrument panel image having placed therein a speedometer image the size of whose speed scale has been further changed, and FIG. 11D illustrates an instrument panel image having placed therein a speedometer image the size of whose speed scale has been corrected by a parameter correction section.

FIG. 12 is a block diagram illustrating the detailed configuration of an instrument panel image changing system including (i) a server having a storage section containing at least either instrument image data or background images and (ii) an instrument panel image display apparatus that acquires, from the server, at least either instrument or background image data to be changed.

### DETAILED DESCRIPTION OF THE PREFERRED EMBODIMENTS

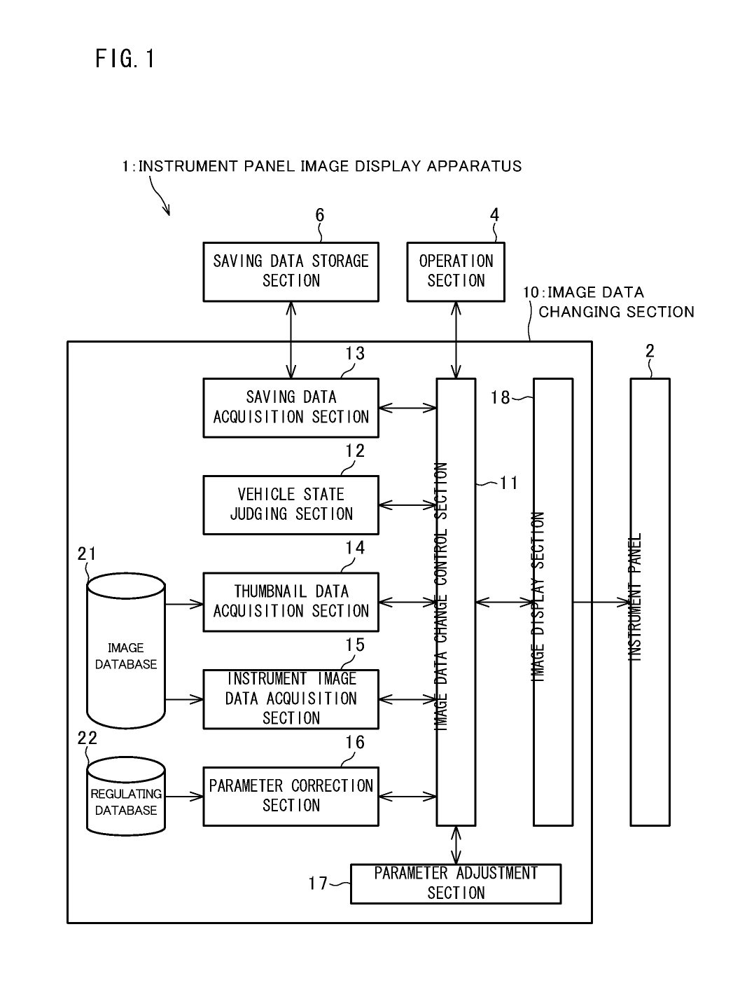

Preferred embodiments of the present invention are described below with reference to FIGS. 1 through 12.

FIG. 1 is a block diagram illustrating an instrument panel image display apparatus 1 according to one preferred embodiment of the present invention. As illustrated in FIG. 1, the instrument panel image display apparatus 1 is schematically constituted by an instrument panel 2, an operation section 4, a saving data storage section 6, and an image data changing section 10.

The instrument panel 2 is a panel display that shows an instrument panel image encoded by instrument panel image data. A good example of the instrument panel 2 is a liquid crystal panel.

It should be noted here that an instrument panel image that is displayed on the instrument panel 2 contains a plurality of “instrument images” that belong to various categories such as a speedometer, a tachometer, an engine temperature gauge, a fuel gauge, various warning lights such as a seat belt warning light, a shift indicator (which indicates the state of a gear), an indicator, navigation which displays a map, a Web window which shows a Web site, a graphic speed display, a numeric speed display, turn signals, and information concerning the surroundings of the vehicle including the vehicle and the condition of the inside of the vehicle, and that provide a driver (user) with various types of information about the inside and outside of the machine mounted therewith. That is, the instrument panel image provides the driver with information vital for or beneficial to driving, entertaining information, or the like. Further, the instrument panel image that is displayed on the instrument panel 2 contains a “background image” that serves as a background against which the instrument images are displayed. In summary, the instrument panel 2 displays an instrument panel image containing instrument images and a background image.

These various instrument images are arranged in specific positions within the instrument panel image, respectively. For example, as will be described later, a speedometer image for showing the traveling speed of the vehicle is placed in the instrument panel image in such a way as to be substantially in the front of the driver or in a position toward the driver. That is, the speedometer image is placed in a position within a range optimally determined in advance to be in the visual field of the driver. In some types of vehicle, an instrument panel may be disposed in the center of a dashboard. Further, the positions in which the instrument images are arranged are determined in advance by categories which the instrument images belong to, but can be changed as will be described later.

It should be noted that the instrument panel image that is displayed on the instrument panel 2 does not need to contain all these types of instrument image. For example, the instrument panel image only needs to contain at least four types out of the instrument images mentioned above. However, in order to secure the safety of the driver, the instrument panel image contains at least instrument images respectively indicating a speedometer, turn signals, a fuel gauge, and an engine temperature gauge.

Further, the instrument panel image data encoding the instrument panel image that is displayed on the instrument panel 2 is composed of plural pieces of instrument image data (image data) respectively encoding these instrument images. Furthermore, the instrument panel image data encoding the instrument panel image does not need to be constituted by all the types of instrument image data mentioned above, either. That is, the instrument panel image data only needs to be composed of data encoding instrument images that are actually displayed on the instrument panel 2.

As will be described later, in the instrument panel image display apparatus 1, various instrument images contained in an instrument panel image that is displayed can each be changed to another image that belongs to the same category. For example, in the instrument panel image display apparatus 1, the speedometer can be changed from analog to digital.

This is realized in the instrument panel image display apparatus 1 by changing instrument image data encoding an instrument image to another piece of instrument image data that belongs to the same category (image data changing step).

Further, the instrument panel image display apparatus 1 allows the driver to make changes in display state of various instrument images. This is realized in the instrument panel image display apparatus 1 by changing a parameter defining the display state of an instrument image.

It should be noted that such a parameter is contained in each piece of instrument image data. Further, such a parameter defines at least one of the following: the size and color of an instrument image; the position of the instrument image within an instrument panel image; the size and color of a font contained in the instrument image; the position of the font within the instrument image; and the like.

Therefore, in the instrument panel image display apparatus 1, for example, by changing a parameter defining the display state of a speedometer image, the size of a numerical value or bar, contained in an analog speedometer, which indicates the traveling speed of a vehicle can be changed, or the color thereof can be changed.

Further, the instrument panel image display apparatus can change the aforementioned various instrument images according to the state of a vehicle. For example, the instrument panel image display apparatus 1 can change from displaying a speedometer image while the vehicle is running at high speed to displaying another speedometer image while the vehicle is running at low speed. Further, the instrument panel image display apparatus 1 can suspend the speedometer display while the vehicle is at rest.

The operation section 4 is used by the driver to operate the instrument panel image display apparatus 1. In the instrument panel image display apparatus 1, a change of at least either an instrument image or a background image, both displayed on the instrument panel 2, to another image, or a change in display state thereof, or the like is made in accordance with various instructions that are inputted through the operation section 4. Specifically, for example, the driver uses the operation section 4 to input a state of the vehicle (e.g., normal, rest, running at low speed, running at high speed, right turn, left turn, or reverse), and a change is made to an instrument panel image corresponding to the state of the vehicle thus inputted. The operation section 4 is an input device such as a mouse, a keyboard, or a touch panel, and instructions may be inputted through an image changing interface that is displayed via an image data change control section 11, an image display section 18, and the instrument panel 2.

The saving data storage section 6 stores therein at least either various types of saving instrument image data indicating instrument images that are displayed on the instrument panel 2 or various types of saving background image data. When starting to operate, the instrument panel image display apparatus 1 usually uses at least either the saving instrument image data or the various saving background image data, both stored in the saving data storage section 6, to display an instrument panel image on the instrument panel 2 as a standard image corresponding to the state of the vehicle as inputted by the driver.

The image data changing section 10 changes at least either an instrument image or a background image, both displayed on the instrument panel 2, to at least either another instrument image or another background image. Further, the image data changing section 10 also has a function of changing the display state of at least either an instrument image or a background image.

The present instrument panel image display apparatus 1 creates an instrument panel image according to a user's own preferences and the state of a vehicle without undermining safety while driving. Moreover, the present instrument panel image display apparatus 1 is characterized especially by the image data changing section 10. Therefore, the configuration, action, and effect of the image data changing section 10 are described below in detail. It should be noted that the image data changing section 10 may be mounted on the vehicle or installed in the vehicle's dealer or the like. When installed in the vehicle's dealer or the like, the image data changing section 10 can be realized by being configured to cause the instrument panel 2 through a network line (described later) to display an instrument panel image.

As illustrated in FIG. 1, the image data changing section 10 includes an image data change control section 11, a vehicle state judging section 12, a saving data acquisition section 13, a thumbnail data acquisition section 14, an instrument image data acquisition section 15, a parameter correction section 16, a parameter adjustment section 17, an image display section 18, an image database 21, and a regulating database 22.

The vehicle state judging section 12 judges a state of the vehicle as inputted by the driver using the operation section 4. Specific examples of the state of the vehicle include “normal”, “rest”, “running at low speed”, “running at high speed”, “right turn”, “left turn”, and “reverse”. Further, the state of the vehicle encompasses an environment surrounding the vehicle, examples of which include “daytime”, “nighttime”, “sunny weather”, “rainy weather”, “warm weather”, and “cold weather”.

The image data change control section 11 controls the overall operation of the image data changing section 10. For example, the image data change control section 11 receives an input signal from the operation section 4 and the vehicle state judging section 12 and outputs signals and data to various members (described later).

The image data change control section 11 includes a memory (not illustrated). In this memory, at least either various types of instrument image data or various types of background image data both acquired from the saving data storage section 6 through the saving data acquisition section 13 (described later) are temporarily stored.

The saving data acquisition section 13 accesses the saving data storage section 6 to acquire at least either saving instrument image data or background image data as a standard image. Further, the saving data acquisition section 13 also has a function of writing at least either saving instrument image data or saving background image data in the saving data storage section 6.

The thumbnail data acquisition section 14 accesses the image database 21 to acquire thumbnail data corresponding to the state of the vehicle as selected by the driver. The thumbnail data encodes a thumbnail representing at least either an instrument image or a background image in a small size. Further, as will be described later, thumbnail data is used by the image display section 19 when the instrument panel 2 displays an image that prompts the driver to select at least either an instrument or background image to be changed. Further, thumbnails of the present preferred embodiment also include various pictures (e.g., symbols representing meters, a shift lever, a seat belt warning light) drawn within rectangles.

The instrument image data acquisition section 15 accesses the image database 21 to acquire at least either instrument image data or background image data. As described above, instrument image data is data encoding each instrument image that constitutes an instrument panel image. Further, as described above, background image data is data encoding a background image that constitutes an instrument panel.

Background image data may be composed of a combination of plural pieces of data.

The instrument image data acquisition section 15 uses an identifier represented by an identifier signal generated by the image data change control section 11, thereby identifying and acquiring, from the image data base 21, at least either instrument image data encoding an instrument image corresponding to the state of the vehicle as selected by the driver or background image data encoding a background image selected by the driver. This is described below in detail.

The parameter correction section 16 determines whether or not at least either the display states of various instrument images or the display states of various background images are within preset regulating ranges (plurality of display states) according to the state of the vehicle. In so doing, the parameter correction section 16 uses a parameter-regulating table, stored in the regulating database 22, for changing at least either an instrument image or a background image. This table is described below in detail.

Further, the parameter correction section 16 uses an identifier represented by an identifier signal generated by the image data change control section 11, thereby identifying and acquiring, from the regulating database 22, a changing parameter value applicable to at least either instrument or background image data to be changed. This is described below in detail, too.

The parameter adjustment section 17 changes, based on a value inputted by the driver through the operation section 4, a parameter defining the display state of at least either an instrument image or a background image.

The image display section 18 causes the instrument panel 2 to display containing instrument images encoded by instrument image data and a background image encoded by background image data. Further, the image display section 18 also has a function of causing the instrument panel 2 to display thumbnails, encoded by thumbnail data, for showing what instrument images and a background image look like.

The image database 21 is a database in which the aforementioned individual pieces of instrument image data encoding instrument images corresponding to states of the vehicle and the aforementioned individual pieces of background image data encoding background images have each been stored in such a form as to be associated with an identifier and a corresponding thumbnail. Specifically, for example, the image database 21 has prepared and stored therein plural types of speedometer images and tachometer images for use “at the time of rest”, “at the time of running at low speed”, “at the time of running at high speed”, and “at the time of reverse” and plural types of blinkers display images for use “at the time of a right turn” and “at the time of a left turn”.

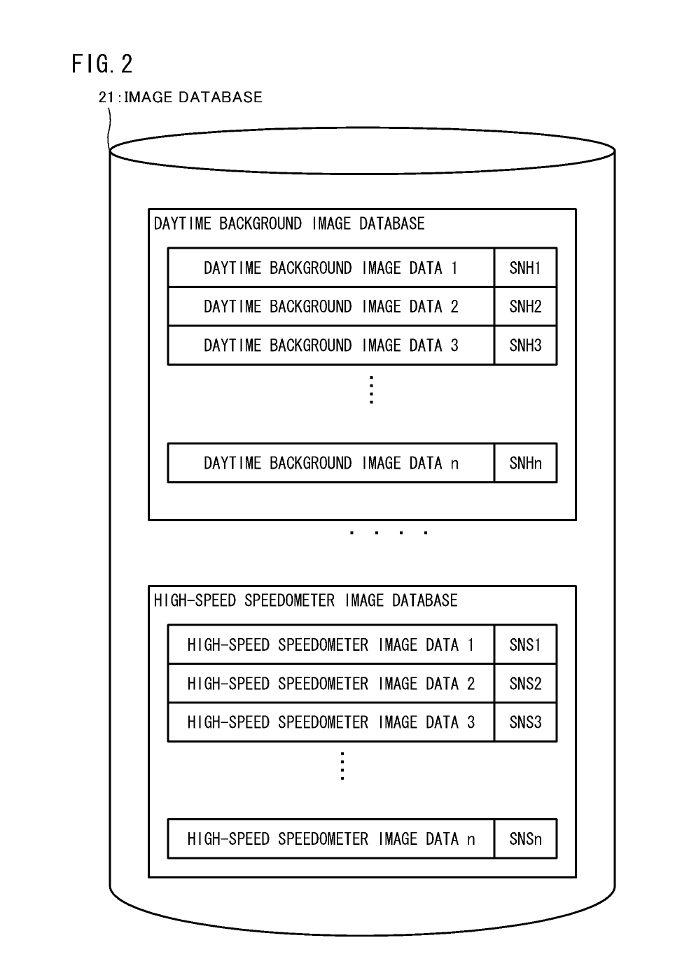

The image database 21 is described below in detail with reference to FIG. 2. FIG. 2 illustrates the details of instrument image data and background image data in the image database 21. As illustrated in FIG. 2, the image database 21 has stored therein sub-databases, such as a daytime background image database and a high-speed speedometer image database, which contain plural types of instrument image data corresponding to respective states of a vehicle.

Such databases have individual pieces of instrument image data each stored therein in such a form as to be associated with an identifier and corresponding thumbnail data. For example, as illustrated in FIG. 2, the daytime background image database has daytime background image data 1 to n (where n is a positive integer) stored therein together with thumbnail data SNH1 to SNHn encoding thumbnails of these images. Further, although not particularly illustrated, the background image data stored in the background image database are in association with identifiers corresponding to these pieces image data.

Similarly, the high-speed speedometer image database has high-speed speedometer image data 1 to n stored therein together with thumbnail data SNS1 to SNSn encoding thumbnails of these images. The speedometer image data stored in the high-speed speedometer image database are in association with identifiers corresponding to these pieces of image data.

Thus, the thumbnail data acquisition section 14 and the instrument image data acquisition section 15 use the identifiers to identify and acquire, from the image database 21, thumbnail data, instrument image data, and background data that are to be acquired. This is described below in detail.

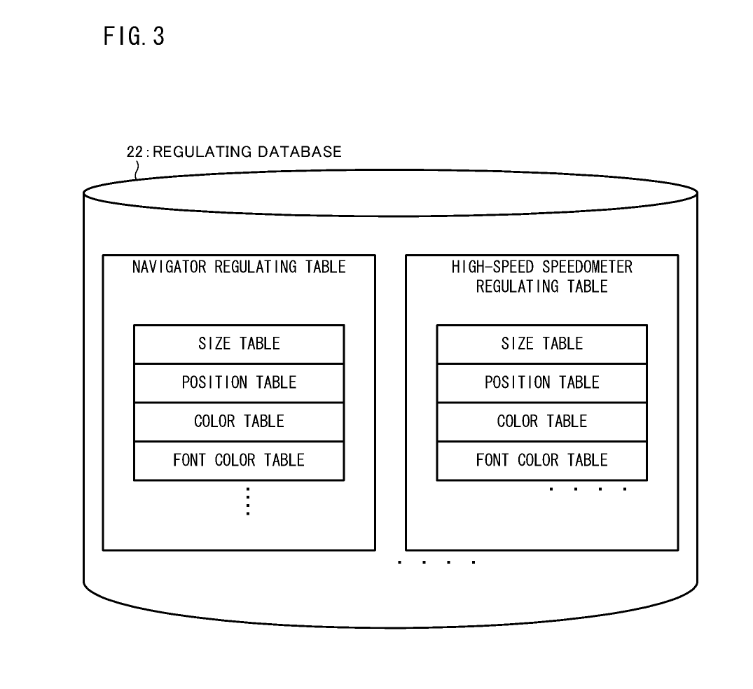

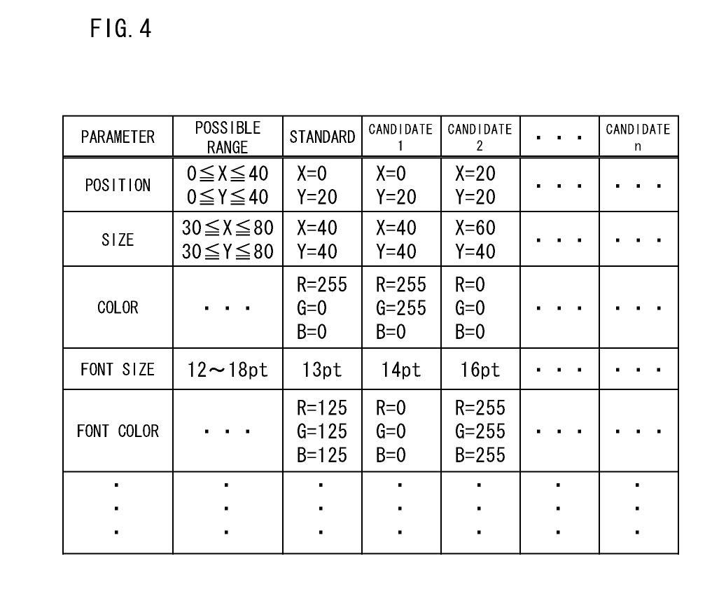

The regulating database 22 is a database that is used for changing a parameter defining the display state of at least either an instrument image or a background image, and that has parameter-regulating tables stored therein. The regulating database 22 is described in detail with reference to FIGS. 3 and 4.

FIG. 3 illustrates the details of parameter-regulating tables contained in the regulating database 22. As illustrated in FIG. 3, the regulating database 22 has stored therein various parameter-regulating tables, such as a navigator regulating table and a high-speed speedometer regulating table, which correspond to respective states of a vehicle. The types of parameter-regulating table are not limited to these, and the regulating database 22 may contain parameter-regulating tables corresponding to other instrument images and other background images that are displayed on the instrument panel 2.

Further, as illustrated in FIG. 3, each parameter-regulating table has stored therein various subtables such as a size table, a position table, a color table, and a font color table. These subtables have stored therein change values that are used for changing various parameters defining the display state of at least either an instrument image or a background image. Therefore, the display state of at least either an instrument image or a background image can be changed within a parameter range indicated in each subtable. Such a parameter range reflects values stipulated by laws, regulations, or the like intended to avoid undermining safety while driving. Therefore, the parameter range can be changed in accordance with a change in stipulated value due to a law amendment or the like. Further, this parameter range is set according to the state of a vehicle. Therefore, the parameter range is set in accordance with the operation condition of the vehicle within a range where safety while driving is not undermined. With an increase in degree of freedom to which an instrument panel image is created, it is anticipated that regulations on displays of instrument panel images will be strengthened. Therefore, in ensuring safety while driving, it is important to set a parameter range in accordance with the state of a vehicle. A process for setting a parameter range in accordance with the state of a vehicle is carried out by a driver, a distribution source of the vehicle, a public institution, or the like.

These subtables are described with reference to FIG. 4. FIG. 4 illustrates an example of a parameter-regulating table that is contained in the regulating database 22.

As illustrated in FIG. 4, a parameter-regulating table has individual subtables for each separate parameter defining the display state of an instrument image. Examples of parameters include the position, size, and color of a high-speed instrument image and the size and color of a font contained in the instrument image. As illustrated in FIG. 4, these subtables each contain a range of values within which the parameter can vary, a normal value of the parameter, and candidates 1 to n for a value that is selected at the time of change in parameter.

A specific example of changing the display state of an instrument image with use of such a regulating database 22 is described later.

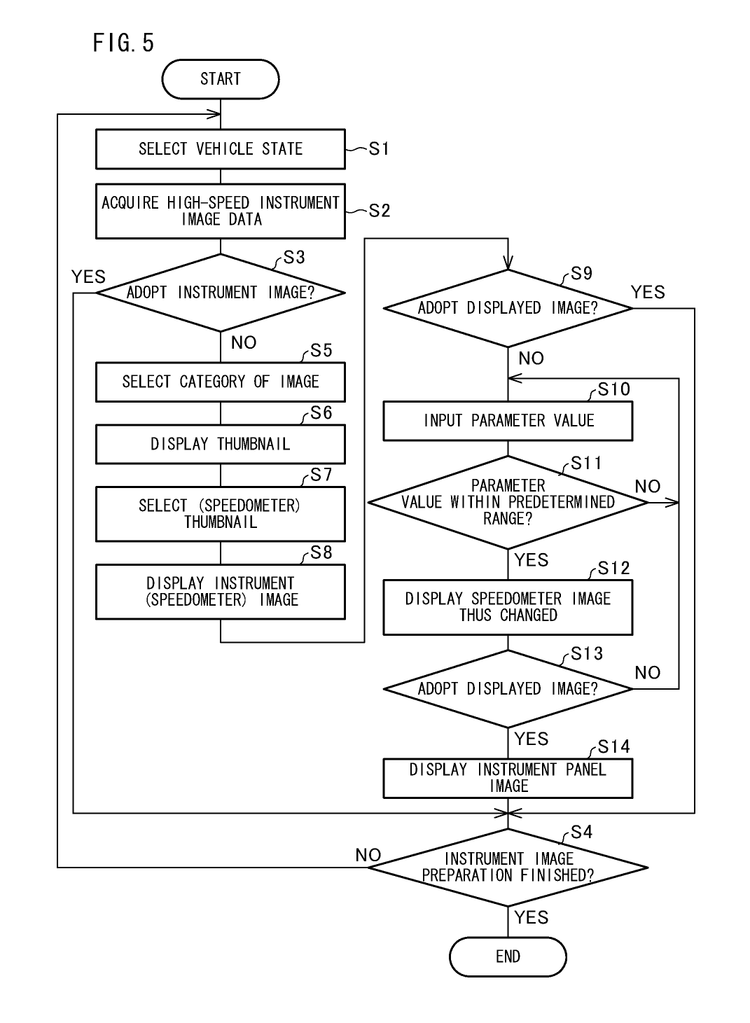

In the following, an operation (instrument image change mode) for changing an instrument image in the instrument panel image display apparatus 1 is described in detail with reference to FIG. 5. FIG. 5 is a flow chart showing the outline of an operation for changing an instrument image.

First, during normal operations, the instrument panel 2 displays an “SELECT VEHICLE STATE” button. When a driver presses down the button through the operation section 4, the instrument panel 2 displays specific states of a vehicle, e.g., “NORMAL”, “RUNNING AT LOW SPEED”, “RUNNING AT HIGH SPEED”, “RIGHT TURN”, “LEFT TURN”, and “REVERSE” buttons. The driver uses the operation section 4 to select a state for which an instrument image is created (S1). The instrument panel image forming apparatus 1 shifts to an instrument image change mode. Specifically, in response to pressing of a button indicating a state of the vehicle (e.g., the “RUNNING AT HIGH SPEED” button here), the operation section 4 outputs a saving data acquisition request signal to the image data change control section 11.

In response to input of the saving data acquisition request signal, the image data change control section 11 outputs the signal to the saving data acquisition section 13, with the result that the saving data acquisition section 13 accesses the saving data storage section 6 to acquire various types of high-speed instrument image data (S2). Then, the saving data acquisition section 13 outputs, to the image data change control section 11, the instrument image data thus acquired.

In response to input of the instrument image data, the image data change control section 11 stores these pieces of data in the memory (not illustrated). Further, the image data change control section 11 causes the instrument panel 2 through the image display section 18 to display “ADOPT” and “CHANGE” buttons, together with the high-speed instrument image thus inputted, in order to ask the driver whether he/she adopts the image (S3). When the driver presses down the “ADOPT” button through the operation section 4 (YES in S3), the high-speed instrument image displayed on the instrument panel 2 is decided on, and then the image data change control section 11 causes the instrument panel 2 through the image display section 18 to display “FINISH” and “CONTINUE” buttons in order to ask the driver whether or not all the necessary instrument images have been prepared (S4). When the driver presses down the “FINISH” button through the operation section 4 (YES in S4), the process is terminated. At this point, the other instrument images, i.e., the instrument images other than the “high-speed” instrument image are determined to be normal standard images. Meanwhile, when the driver presses down the “CONTINUE” button through the operation section 4 (NO in S4), the process returns to Step S1, where a state of the vehicle is selected.

At this point, when the driver does not adopt but would like to change the high-speed instrument image displayed on the instrument panel 2 and presses down the “CHANGE” button (NO in S3), the image data change control section 11 outputs an instrument image change mode shift signal to the image display section 18. In response to input of the signal, the image display section 18 switches the instrument panel 2 to displaying a window where the driver can select a category of instrument image that he/she would like to change. For example, the image display section 18 causes the instrument panel 2 to display a message on an upper portion thereof. An example of the message is “SELECT A CATEGORY OF IMAGE THAT YOU WOULD LIKE TO CHANGE”.

Next, the driver uses the operation section 4 to select, from among the various high-speed instrument images displayed on the instrument panel 2, which category of image he/she is going to change (S5). In this case, for example, the driver operates the operation section 4 to select one of the instrument images displayed on the instrument panel 2. When the operation section 4 is a mouse, the driver clicks twice. In the result, the operation section 4 outputs, to the image data change control section 11, a category identification signal representing the category (e.g., speedometer, tachometer) of instrument image to be changed. Let it be assumed here that the driver has selected the speedometer category.

In response to input of the category identification signal representing the speedometer category, the image data change control section 11 analyzes the signal and identifies a category of instrument (speedometer) image data to be acquired. Based on a result of the identification, the image data change control section 11 generates an identifier signal associated with thumbnail data encoding thumbnails of speedometer images belonging to the category selected by the driver. Further, in response to input of the category identification signal, the image data change control section 11 adds, to the signal, a vehicle state identification signal representing the state of the vehicle (here, running at high speed). Then, the image data change control section 11 outputs, to the thumbnail data acquisition section 14, the identifier signal thus generated.

In response to input of the identifier signal, the thumbnail data acquisition section 14 accesses the image database 21. Then, the thumbnail data acquisition section 14 acquires the thumbnail data from the image database 21 by using an identifier represented by the identifier signal. The thumbnail data acquired at this point encode thumbnails corresponding to a plurality of selectable speedometer images belonging to the category of the high-speed speedometer image selected by the driver to be changed. The thumbnail data acquisition section 14 outputs, to the image data change control section 11, the thumbnails thus acquired.

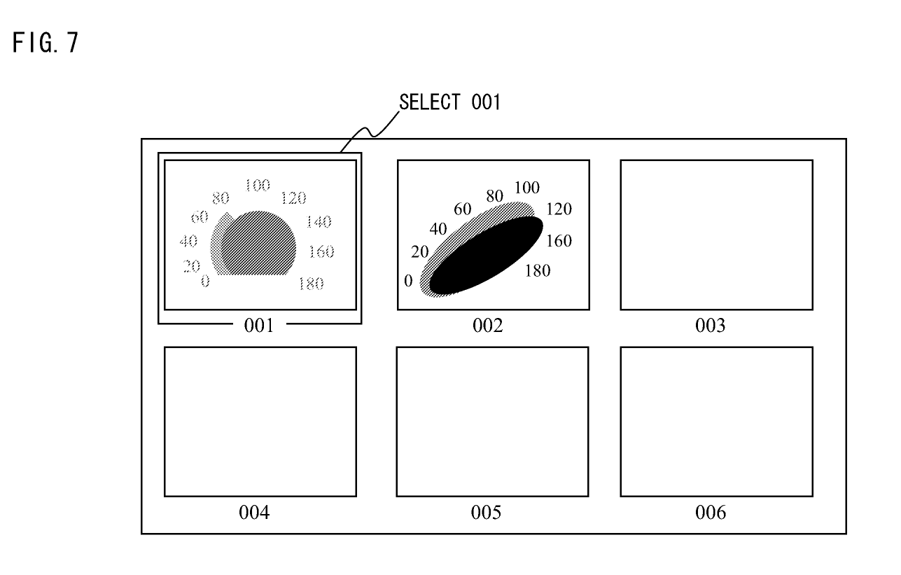

In response to input of the thumbnail data, the image data change control section 11 outputs the data to the image display section 18. Then, the image display section 18 uses the thumbnails to cause the instrument panel 2 to display a window that prompts the driver to select a speedometer image to which he/she changes (S6). At this point, the instrument panel 2 displays thumbnails as illustrated in FIG. 7, for example.

After that, the driver uses the operation section 4 to decide which image he/she selects from among the various speedometer images displayed as thumbnails on the instrument panel 2 (S7). Specifically, for example, the driver uses the operation section 4 to click twice on one of the thumbnails displayed on the instrument panel 2, whereby the operation section 4 outputs, to the image data change control section 11, an image identification signal representing the type of speedometer to which the driver changes.

In response to input of the image identification signal, the image data change control section 11 analyzes the signal and identifies the speedometer image to which the driver changes. Based on a result of the identification, the image data change control section 11 generates an identifier signal associated with speedometer image data encoding the speedometer image selected by the driver. Then, the image data change control section 11 outputs, to the instrument image data acquisition section 15, the identifier signal thus generated.

In response to input of the identifier signal, the instrument image data acquisition section 15 accesses the image database 21. Then, the instrument image data acquisition section 15 acquires the speedometer image data from the image database 21 by using an identifier represented by the identifier signal. The speedometer image data acquired at this point encodes the high-speed speedometer image, selected by the driver, to which he/she changes. The instrument image data acquisition section 15 outputs, to the image data change control section 11, the speedometer image data thus acquired.

In response to input of the speedometer image data, the image data change control section 11 outputs the data to the image display section 18. Then, the image display section 18 updates the display on the instrument panel 2 by using the speedometer image data thus inputted. Specifically, the image display section 18 replaces, with the speedometer image encoded by the speedometer image data thus inputted, a place where a speedometer image belonging to the category is displayed, so that the replacing speedometer image is displayed (S8; display step).

It should be noted here that the present instrument panel image display apparatus 1 can adjust the display state of a speedometer image in addition to changing a displayed speedometer image to another image. For example, the instrument panel image display apparatus 1 can change the size and color of each speedometer image and the position and the like of each speedometer image within an instrument panel image. This is described below.

In S8 above, when the replacing speedometer image is displayed, the driver uses the operation section 4 to decide whether or not to adopt the displayed speedometer image. Specifically, the image display section 19 causes the instrument panel 2, for example, to display “ADOPT” and “ADJUST” buttons (S9). When the driver presses down the “ADOPT” button (YES in S9), the displayed speedometer image is decided on, and the process shifts to Step S4, where the driver is asked whether or not all the necessary instrument images have been prepared.

On the other hand, when the driver presses down the “ADJUST” button (NO in S9), the operation section 4 outputs, to the image data change control section 11, an adjustment image identification signal identifying the speedometer image whose display state is to be changed.

In response to input of the adjustment image identification signal, the image data change control section 11 first identifies, based on the signal, speedometer image data encoding the speedometer image whose parameters are to be adjusted. Then, the image data change control section 11 accesses the memory (not illustrated) to retrieve the speedometer image data whose parameters are to be adjusted. Furthermore, the image data change control section 11 identifies types (e.g., size, color, and position) of various parameters, contained in the speedometer image data thus retrieved, which defines the display state of the speedometer image. Based on a result of the identification, the image data change control section 11 outputs, to the image display section 18, a signal representing the types of parameter thus identified.

In response to input of the signal, the image display section 18 causes the instrument panel 2 to display a window that prompts the driver to input a parameter value to which the driver changes. At this point, the driver uses the operation section 4 to input a parameter value that defines the display state of the displayed high-speed speedometer image (S10). For example, the driver uses the operation section 4 to input the height and width of the speedometer image. Then, in response to the input, the operation section 4 outputs, to the image data change control section 11, the parameter value inputted by the driver.

In response to input of the parameter value, the image data change control section 11 outputs, to the parameter correction section 16, high-speed speedometer image data stored in the memory (not illustrated). The parameter correction section identifies an identifier corresponding to a high-speed speedometer image encoded by the high-speed speedometer image data.

Next, the parameter correction section 16 accesses the regulating database 22 to identify, based on the identifier thus identified, a parameter-regulating table (high-speed speedometer regulating table here) to be used. The parameter correction section 16 determines whether or not the parameter value inputted by the driver is a value falling within a range, specified in the high-speed parameter-regulating table, within which the parameter can vary (S11). This determination allows the instrument panel image display apparatus 1 to detect, in advance, an instrument panel image containing a speedometer image that is displayed in such a way as to undermine safety while driving (e.g., to impair visibility).

If the parameter value inputted by the driver does not fall within the stipulated range (NO in S11), the image data change control section 11 causes the instrument panel 2 through the image display section 18 to display an indication that the parameter value inputted is an improper value, e.g., to display “NG”, and returns to S10 to prompt the driver to input another parameter value.

On the other hand, if the parameter value inputted by the driver falls within the stipulated range (YES in S11), the image data change control section 11 outputs, to the parameter adjustment section 17, the parameter value thus inputted and the speedometer image data whose parameters are to be adjusted. In response to the data and the parameter value, the parameter adjustment section 17 rewrites, with the value thus inputted, the parameter values contained in the speedometer image data. Then, the parameter adjustment section 17 outputs, to the image data change control section 11, the speedometer image data whose parameter values have been rewritten.

In response to input of the data, the image data change control section 11 writes the data in the memory (not illustrated). Furthermore, the image data change control section 11 outputs the data to the image display section 18. Then, the image display section 18 updates the display on the instrument panel 2 by using the speedometer image data whose parameters have been changed, whereby the instrument panel 2 displays the speedometer image whose display state has been changed according to the parameter value inputted by the driver (S12).

The image display section 18 causes the instrument panel 2 to display, together with the high-speed speedometer image whose state has been adjusted to suit the driver's own preferences, a message asking the driver to confirm whether or not the current display state is OK (S13). At this point, for example, the instrument panel 2 displays “OK” and “REENTER” buttons.

At this point, when the driver presses down the “REENTER” button through the operation section 4 (NO in S13), the process returns to S10, where the image display section 18 causes the instrument panel 2 to display a window that prompts the driver to input a parameter value to which he/she changes. S10 and its subsequent steps are repeated until the driver presses down the “OK” button.

On the other hand, when the driver presses down the “OK” button through the operation section 4 (YES in S13), the operation section 4 outputs an image change completion signal to the image data change control section 11. In response to input of the image change completion signal, the image data change control section 11 outputs the signal to the image display section 18. At this point, in response to input of the image change completion signal, the image display section 18 causes the instrument panel 2 to display a high-speed instrument panel image (S14). Meanwhile, the image data change control section 11 outputs a saving data update signal to the saving data acquisition section 13, together with the high-speed image data. In response to input of the data and the signal, the saving data acquisition section 13 writes the high-speed image data in the saving data storage section 6.

With this process, an instrument panel image that is displayed on the instrument panel 2 is updated to be a new instrument panel image that is displayed in combination with a new speedometer image to which the driver has changed. After that, having shifted to S4, the image data change control section 11 asks the driver whether or not all the necessary instrument images have been prepared. Then, when a “FINISH” button is pressed down (YES in S4), the process is terminated. On the other hand, when a “CONTINUE” button is pressed down (NO in S4), the process returns to S1, where a state of the vehicle is selected.

Such a configuration as to select another category (e.g., tachometer) in the same state of the vehicle (i.e., “running at high speed” in the aforementioned example) instead of returning to Step can be realized by further adding a “SELECT CATEGORY” button. Specifically, the image display section 18 causes the instrument panel 2 to display the “FINISH”, “CONTINUE”, and “SELECT CATEGORY” buttons and, in cases where the driver presses down the “SELECT CATEGORY” button, the process shifts to Step S5, where the driver selects, from among the various high-speed instrument images displayed on the instrument panel 2, which category of image he/she is going to change.

It is preferable, in S4, that the image data change control section 11, which has received the signal indicating that the necessary instrument image has been created (“FINISH”), check an instrument image created for each state of the vehicle, so as to confirm that all the instrument images exist. Specifically, the image data change control section 11 confirms that the necessary instrument images surely exist, for example, by asking questions such as “Does a speedometer exist?” and “Do turn signals exist?”. This makes it possible to surely prevent creation of an instrument panel image deviating from laws and regulations.

By thus adjusting the display state of an instrument panel image repeatedly for various instrument images contained in the instrument panel image, the respective display states of various instrument images that are displayed on the instrument panel 2 are changed according to values inputted by the driver in accordance with a state of the vehicle.

That is, in the instrument panel image display apparatus 1, a parameter defining the display state of an image represented by instrument image data is changed to another value (i.e., a value inputted by the driver), whereby the display state of an instrument image that is displayed on the instrument panel 2 can be changed for each state, i.e., operation condition, of the vehicle. With this, in the instrument panel image display apparatus 1, the instrument panel 2 can display an instrument panel image whose display state has been changed by the driver according to the state of the vehicle to suit his/her own preferences within a range of regulations concerning safety. Therefore, the instrument panel image display apparatus 1 can create an instrument panel image according to the driver's own preferences and the state of the vehicle without undermining safety while driving.

The aforementioned process is configured such that when in S9 the driver presses down the “ADJUST” button instead of adopting the speedometer image acquired from the image database 21, the instrument panel 2 displays a window that prompts the driver to input a parameter value to which the driver changes. Alternatively, the aforementioned process may be configured, for example, such that when the “ADJUST” button is pressed down, the parameter is changed to one of the parameter values, stored in advance in a parameter-regulating table, at which an optimum display state is attained. A specific example of the configuration is described below.

In this configuration, as illustrated in FIG. 4, a parameter-regulating table contains candidates 1 to n for an optimum value that a parameter is supposed to take on. At this point, the parameter correction section 16 changes the parameters to the values of the first candidate (candidate 1) first.

The image data change control section 11 outputs, to the parameter adjustment section 17, the parameter values of the candidate 1 and the speedometer image data whose parameters are to be adjusted. In response to the data and the parameter values, the parameter adjustment section 17 rewrites, with the values of the candidate 1, the parameters contained in the speedometer image data. Then, the parameter adjustment section 17 outputs, to the image data change control section 11, the speedometer image data whose parameters have been rewritten.

In response to input the data, the image data change control section 11 writes the data in the memory (not illustrated). Furthermore, the image data change control section 11 outputs the data to the image display section 18. Then, the image display section 18 updates the display on the instrument panel 2 by using the speedometer image data whose parameters have been changed, whereby the instrument panel 2 displays the speedometer image whose display state has been changed according to the values of the candidate 1. In so doing, the image display section 18 causes the instrument panel 2 to display a message asking the driver to confirm whether or not the current display state is OK. At this point, for example, the instrument panel 2 displays “OK” and “NEXT CANDIDATE” buttons.

At this point, when the driver presses down the “NEXT CANDIDATE” button through the operation section 4, the operation section 4 outputs a next-candidate selection signal to the image data change control section 11. In response to input of the signal, the image data change control section 11 outputs, to the parameter correction section 16, the next-candidate selection signal and the speedometer image data stored in the memory (not illustrated), whereby the parameter correction section 16 accesses the regulating database 22 to acquire parameter values of the next correction candidate (candidate 2). Then, the parameter correction section 16 changes, to the values of the next candidate, the values of the parameters contained in the speedometer image.

In response to input of the speedometer image data changed based on the parameter values of the candidate 2, the image data change control section 11 stores the speedometer image data temporarily in the memory (not illustrated) as mentioned above. Then, the image data change control section 11 outputs the speedometer image data to the image display section 18.

In response to input of the data, the image display section 18 updates the instrument panel image on the instrument panel 2 by using the speedometer image data whose parameters have been changed to the values of the candidate 2. In so doing, the image display section 18 causes the instrument panel 2 to again display a message asking the driver to confirm whether or not the current display state is OK. At this point, as mentioned above, the instrument panel 2 displays the “OK” and “NEXT CANDIDATE” buttons.

At this point, when the driver presses down the “NEXT CANDIDATE” button again, the parameters contained in the speedometer image data are rewritten to the values of the further next candidate (candidate 3) included in the correction data, through the aforementioned flow of the process. This process can be repeated until the last candidate (candidate n) included in the correction data is used.

On the other hand, when the driver presses down the “OK” button through the operation section 4, the operation section 4 outputs an image change completion signal to the image data change control section 11. In response to input of the image change completion signal, the image data change control section 11 outputs the signal to the image display section 18. At this point, in response to input of the image change completion signal, the image display section 18 causes the instrument panel 2 to display a high-speed instrument panel image. Meanwhile, the image data change control section 11 outputs a saving data update signal to the saving data acquisition section 13, together with the instrument image data. In response to input the data and the signal, the saving data acquisition section 13 writes the instrument image data in the saving data storage section 6.

With this process, an instrument panel image that is displayed on the instrument panel 2 at the time of running at high speed is updated to be a new instrument panel image that is displayed as a combination of new instrument images to which the driver has changed.

It should be noted that the parameter correction section 16 may be configured such that when it is determined, in S11 of the aforementioned process, that the parameter value inputted by the driver is out of the range of values, stored in the parameter-regulating table, within which the parameter can vary, the parameter correction section 16 automatically changes the input parameter value to a value falling within the range, stored in the parameter-regulating table, within which the parameter can vary. In particular, it is preferable that the parameter correction section 16 change the input parameter value to a value, falling within the range within which the parameter can vary, which is closest to the input parameter value. For example, in cases where a parameter is 100 and can vary within a value range of 50 to 70, the parameter correction section 16 sets the parameter to 70. This makes it possible to automatically set the display state of an image to a state closest to the display state that the driver would like, thus making it possible to save the driver the trouble of reentering a parameter value.

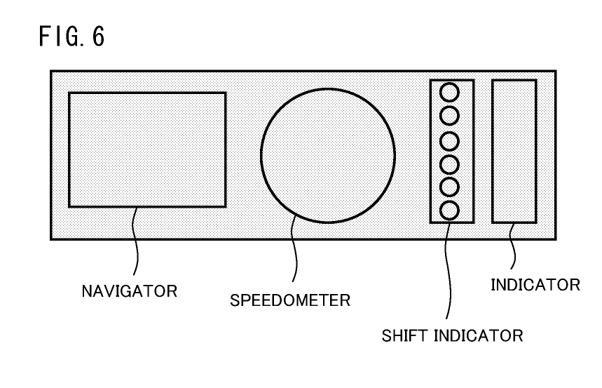

A specific example of the aforementioned process for changing an instrument image is described below with reference to FIGS. 6 through 11.

FIG. 6 illustrates examples of various instrument images that can be arranged within an instrument panel image. In FIG. 6, an instrument panel image that is displayed on the instrument panel 2 is constituted by a combination of at least either various instrument images respectively indicating a navigator, a speedometer, and a shift indicator or a background image.

At this point, when the driver chooses through the operation section 4 to change the high-speed speedometer image, the instrument panel 2 displays, as illustrated in FIG. 7, thumbnail high-speed speedometer images 001 to 006 stored in the image database 21. As illustrated in FIG. 7, the driver has selected the thumbnail 001.

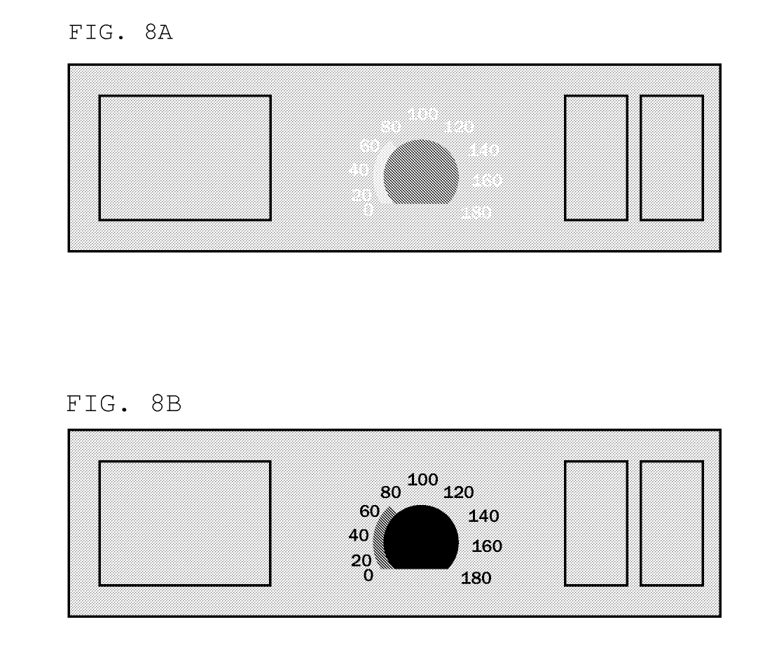

Then, as illustrated in FIG. 8A, the speedometer image selected by the driver, i.e., the speedometer image corresponding to the thumbnail 001 is displayed in a position within the instrument panel image of FIG. 6 where a speedometer image is disposed. However, in FIG. 8A, the speedometer image selected by the driver is very similar in coloration to the background image; therefore, the speedometer image is not displayed clearly. Such a display state makes it difficult for the driver to see the speed of the vehicle while driving. Such a difficulty causes an increase in the risk of an accident.

In view of this, as mentioned above, the instrument panel image display apparatus 1 uses the function of the parameter correction section 16 to judge a speedometer image displayed as illustrated in FIG. 8A. Specifically, in S8 of the flow diagram of FIG. 5, the parameter correction section 16 makes a comparison between the parameter of coloration of the speedometer image selected by the driver and the parameter of coloration of the background image. Then, in cases where the values approximate to each other, the image data change control section 11 causes the display panel 2 to display “NG” and prompts the driver to select another speedometer image with use of a thumbnail. At this point, in cases where the speedometer image thus selected is judged to be “OK”, a process for making an adjustment to the speedometer image is carried out as mentioned above, whereby the instrument panel image of FIG. 8A is corrected to be an image of FIG. 8B. FIG. 8B illustrates an instrument panel image having a corrected speedometer image placed therein. In FIG. 8B, the speed scale and the bar that shows the current speed of the vehicle are now fairly visible, although they blended in with the background image and therefore were hardly visible before the correction. Thus, the instrument panel image display apparatus 1 corrects instrument image data so that a speedometer image can be seen by the driver with clarity.

The instrument panel image display apparatus 1 may be configured, as mentioned above, to use the function of the parameter correction section 16 to automatically correct a speedometer image displayed as illustrated in FIG. 8A to be displayed in such a way, as illustrated in FIG. 8B, that the speedometer can be seen by the driver with clarity.

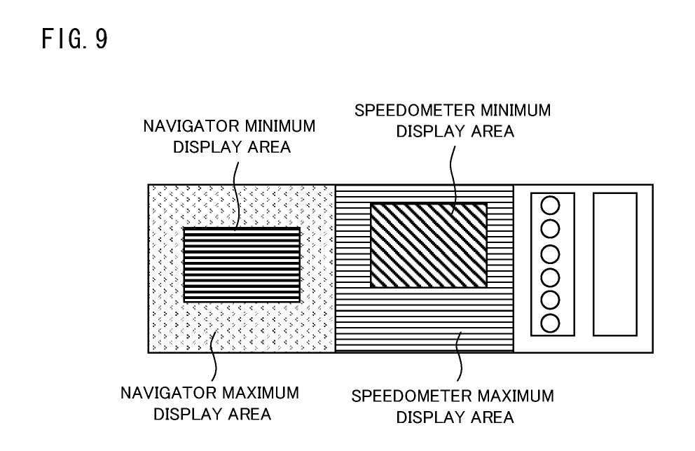

Further, the correction of instrument image data by the parameter correction section 16 is also effective in correction of instrument image data adjusted by the parameter adjustment section 17. This example is described below with reference to FIGS. 9 through 11.

FIG. 9 illustrates examples of ranges of areas that can be occupied by various instrument images that are arranged within an instrument panel image. FIG. 9 shows minimum and maximum display areas where a navigator image and a speedometer image are respectively displayed within the instrument panel image. These regions can be calculated from parameter-regulating tables stored in the regulating database 22. That is, these regions can be calculated in accordance with values, contained in the parameter-regulating tables, which represent possible size ranges and possible position ranges.

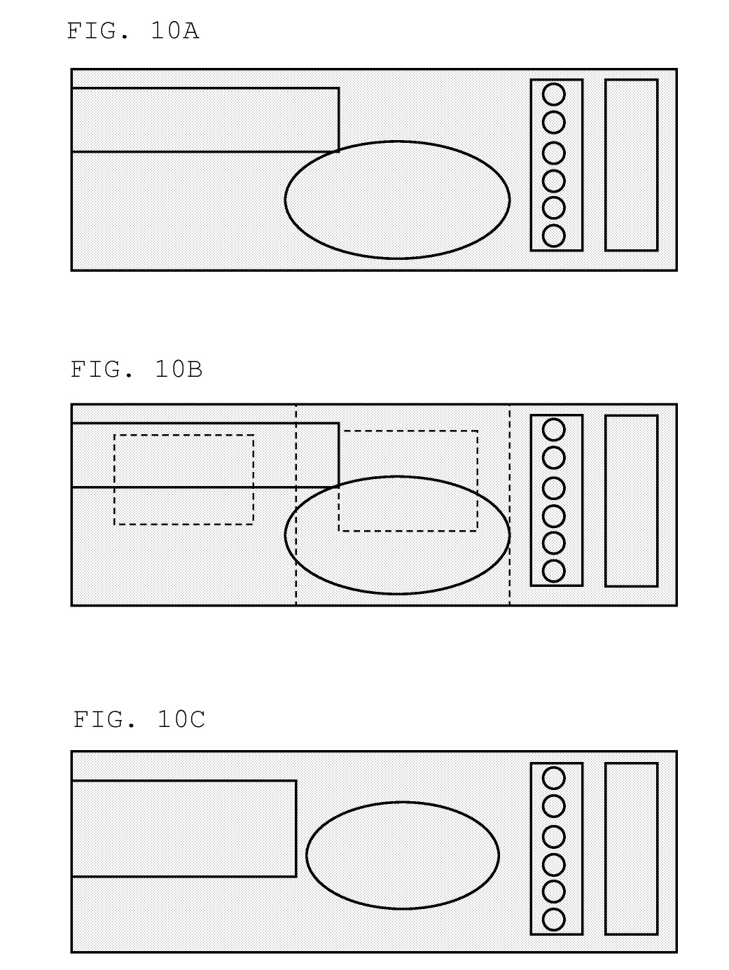

Let it be assumed here that the driver has changed the sizes and positions of the navigator and speedometer images as illustrated in FIG. 10A through the operation section 4 and the parameter adjustment section 17. Then, as indicated by the dotted lines in FIG. 10B, the instrument images thus adjusted are both protruding from the respective maximum display areas.

At this point, the parameter correction section 16 determines that the values of the size and position parameters of the navigator and speedometer images are not within the ranges, defined in the parameter-regulating tables, within which the parameters can vary, respectively. Then, the image data change control section 11 causes the instrument panel 2 through the image display section 18 to display an indication that the input parameters are taking on improper values, thereby prompting the driver to input the parameters again.

Thus, as illustrated in FIG. 10C, the navigator and speedometer images are both adjusted in such a way as to fit into the respective maximum display areas. This makes it possible to prevent the instrument images from being overlapped with each other within the instrument panel image or from being made too small in size for the driver to see.

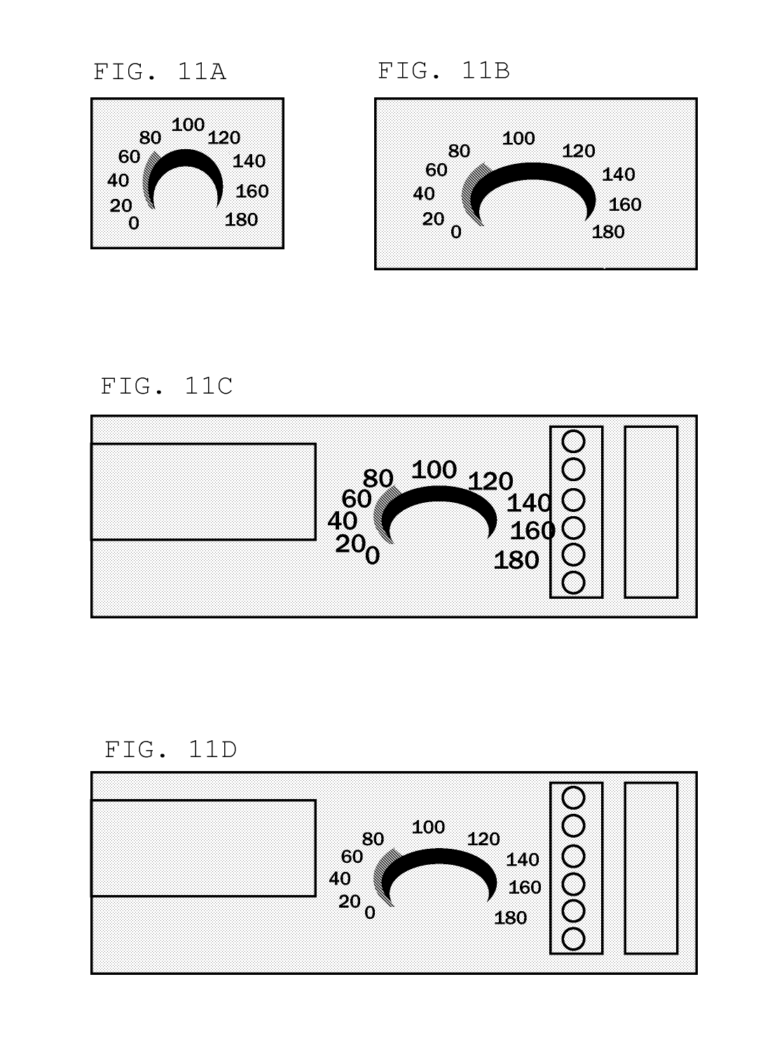

FIGS. 11A-D illustrate another example of correction of a speedometer image. FIG. 11A illustrates a high-speed speedometer image selected by the driver through the operation section 4. The display state of this image has been neither adjusted by the parameter adjustment section 17 nor corrected by the parameter correction section 16. That is, this image is one of the plural pieces of image data stored in the high-speed speedometer image database.

When the driver adjusts the size of this image through the parameter adjustment section 17, the image looks as illustrated in FIG. 11B, for example. It should be noted that in this speedometer image, the display state of the speed scale on the speedometer and the display state of the other sections (e.g., the bar that shows the current speed) can be set independently of each other. Whereas the respective sizes of the bar that shows the current speed and the like, as illustrated in FIG. 11B, have been changed in accordance with a change in size of the whole image, the size of each speed-measuring mark of the speed scale has not been changed. Instead, the position where each speed-measuring mark is placed within the speedometer image has been changed in accordance with the change in size of the whole image.

At this point, when the driver further increases the size of the speed scale in the image of FIG. 11B through the operation section 4 and the parameter adjustment section 17 and then places each speed-measuring mark in the instrument panel image, the instrument panel image looks as illustrated in FIG. 11C. As illustrated in FIG. 11C, the speed scale, whose size has been set by the user through the parameter adjustment section 17, is ill-proportioned in size to the speed bar. Therefore, the speed scale and the speed bar look unbalanced to the driver. Further, the speed scale is overlapping the shift indicator image, and is therefore hard for the driver to see. Therefore, in such a case, the driver is prompted to input the parameter indicative of the size of the speed scale again in accordance with the parameter-regulating table stored in advance in the regulating database 22.

This makes it possible to correct the size of the speed scale of the speedometer image to a display state falling within the range of regulation. An image changed as a result of such correction is illustrated in FIG. 11D. As illustrated in FIG. 11D, the post-correction speedometer image has the speed scale and the speed bar adjusted in size in a balanced manner, and is therefore easy for the driver to see. Further, the speed scale and the shift indicator image do not overlap each other, and are therefore both easy to see.

It is preferable that on the basis of the display state of a speedometer image placed within an instrument panel image, the instrument panel image display apparatus 1 correct the speedometer image or another instrument image. That is, in the present instrument panel image display apparatus 1, the parameter correction section 16 corrects parameters defining the respective display states of various instrument images so that the speedometer image is corrected to be in such a display state as to be seen by a driver with clarity.

For example, a speedometer is an instrument that presents the driver with the speed of a vehicle that he/she is driving, and is one of the most important instruments for the driver to drive the vehicle safely. Therefore, it is most preferable that within an instrument panel image, a speedometer image be placed in a predetermined position within a range optimally determined in advance to be either in a position right in front of the driver or in the visual field of the driver. This allows the driver to confirm the speed of the vehicle with minimum movements of his/her eyes.

For that purpose, it is preferable that the regulating database 22 have stored therein values defining a possible region of placement of this image so that the speedometer image after correction is disposed within the instrument panel image in such as way as to be substantially in the front of the driver. With this, even if the driver places the speedometer image on an edge side of the instrument panel image, the parameter correction section 16 makes a correction so that the speedometer image is placed in a position near the front of the driver. This makes it possible to prevent the speedometer image from being placed within the instrument panel image in such a state that it is hard for the driver to see the speedometer image.

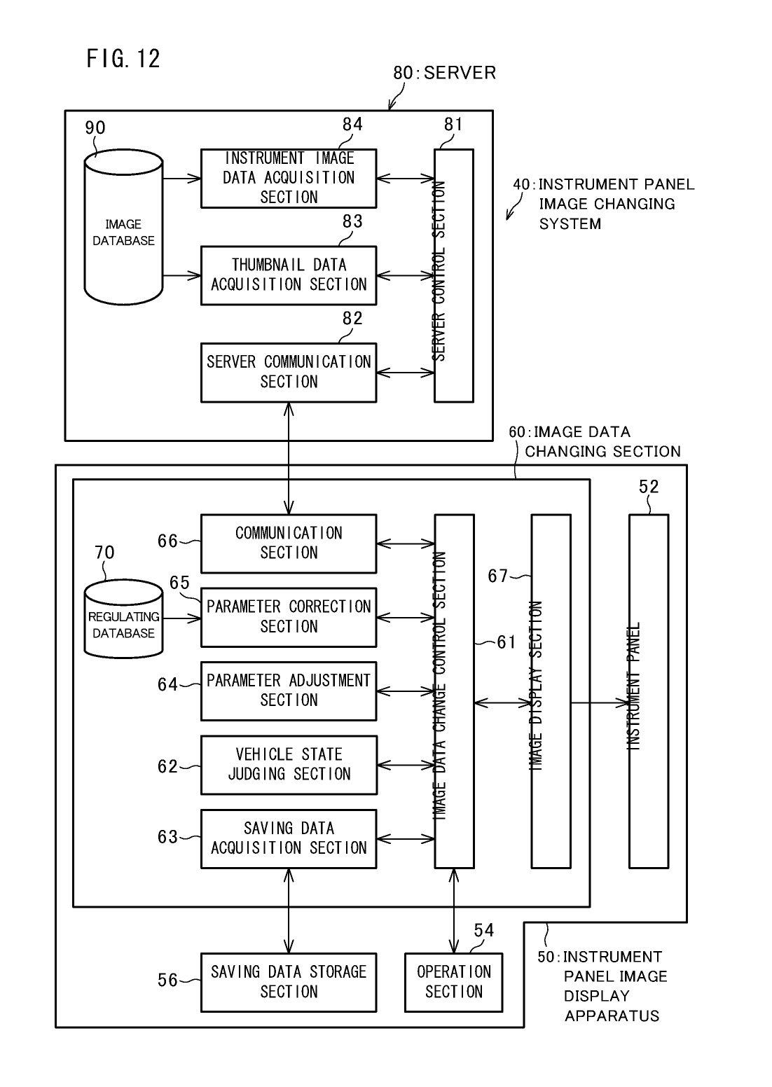

An instrument panel image display apparatus of the present invention may be configured, as illustrated in FIG. 12, such that instrument image data encoding an instrument image to be changed is acquired through a network line from a server having a storage section having instrument image data stored therein. In this case, the instrument panel image display apparatus and the server constitute an instrument panel image changing system. The same applies to background image data.

The following describes an instrument panel image changing system 40 illustrated in FIG. 12. FIG. 12 is a block diagram illustrating the detailed configuration of the instrument panel image changing system 40, which includes (i) a server 80 having a storage section having instrument image data stored therein and (ii) an instrument panel image display apparatus 50 that acquires, from the server 80, instrument image data to be changed. As illustrated in FIG. 12, the present instrument panel image changing system 40 includes the instrument panel image display apparatus 50 and the server 80.

It should be noted here that, as illustrated in FIG. 12, the instrument panel image display apparatus 50 includes an instrument panel 52, an operation section 54, a saving data storage section 56, and an image data changing section 60. Among these, the instrument panel 52, the operation section 54, and the saving data storage section 56 are identical in configuration to the instrument panel 2, the operation section 4, the saving data storage section 6, and the user-by-user image data storage section 7, and as such, are not described below.

It should be noted that the instrument panel image display apparatus 50 is characterized by the image data changing section 60. Therefore, the image data changing section 60 is described in detail with reference to FIG. 12.

As illustrated in FIG. 12, the image data changing section 60 includes an image data change control section 61, a vehicle state judging section 62, a saving data acquisition section 63, a parameter adjustment section 64, a parameter correction section 65, a communication section 66, and an image display section 67. Among these, the vehicle state judging section 62, the saving data acquisition section 63, the parameter adjustment section 64, the parameter correction section 65, the image display section 67, and the regulating database 70 preferably are identical in configuration to the vehicle state judging section 12, the saving data acquisition section 13, the parameter adjustment section 17, the parameter correction section 16, the image display section 18, and the regulating database 22 respectively, and as such, are not described below.

The communication section 66 sends a thumbnail data request signal and an instrument image data request signal to a server communication section 82 provided in the server 80. These signals will be described later. Further, the communication section 66 also has a function of receiving thumbnail data and instrument image data sent from the server communication section 82. That is, in the present instrument panel image display apparatus 50, the communication section 66 has a function of acquiring thumbnail data and instrument image data from the server 80 through the network line.

The image data change control section 61 has a function of generating a thumbnail data request signal and an instrument image data request signal that are sent by the server communication section 82, in addition to controlling the overall operation of the image data changing section 60. This will be described in detail later.

As illustrated in FIG. 12, the server 80 includes a server control section 81, the sever communication section 82, a thumbnail data acquisition section 83, an instrument image data acquisition section 84, and an image database 90.

The server control section 81 controls the overall operation of the server 80.

The server communication section 82 receives a thumbnail data request signal and an instrument image data request signal that are sent from the communication section 66. Further, the server communication section 82 also has a function of sending thumbnail data and instrument image data to the communication section 66.

The image database 90 is a database in which instrument image data encoding various instrument images, such as a high-speed speedometer image, which correspond to respective states of a vehicle have been stored in association with identifiers and corresponding thumbnails. In this respect, the image database 90 is identical to the image database 21. However, unlike the image database 21, the image database 90 have stored therein instrument image data corresponding to various types of vehicle and instrument panel image display apparatus, as well as to a particular instrument panel image display apparatus.

That is, the image database 90 has instrument image data and thumbnail data stored in such a form as to be associated with vehicle type identifiers representing types of vehicle in which these pieces of data can be used and apparatus identifiers representing types of instrument panel image display apparatus 50, as well as with identifiers for identifying the respective pieces of data. Therefore, the server 80, which includes the image database 90, can provide, in response to a request from a vehicle or an apparatus, instrument image data requested by various types of instrument panel image display apparatus 50 mounted on various types of vehicle.

In the following, the instrument panel image changing system 40 is described in detail.

In this system, the instrument panel image display apparatus 50 is in common with the aforementioned instrument panel image display apparatus 1 up to the point where the instrument panel 2 shows the driver a window that prompts him/her to input a choice of a category of instrument image to be changed. In response to the window thus displayed, the driver uses the operation section 54 to select a category (e.g., speedometer, tachometer) of instrument image, corresponding to the state of the vehicle, which he/she would like to change. Then, the operation section 4 outputs, to the image data change control section 61, a category identification signal representing the category of instrument image, corresponding to the state of the vehicle, which is to be changed.

In response to input of the category identification signal, the image data change control section 61 generates a thumbnail data request signal by adding, to the category identification signal, an apparatus identification signal representing the type of instrument panel image display apparatus 50 and a vehicle identification signal representing the type of vehicle mounted with the instrument panel image display apparatus 50. Then, the image data change control section 61 outputs the thumbnail data request signal to the communication section 66.

In response to input of the thumbnail data request signal, the communication section 66 sends the signal to the server communication section 82. Then, upon receiving the thumbnail data request signal, the server communication section 82 outputs the signal to the server control section 81.

In response to input of the thumbnail data request signal, the server control section 81 analyzes the signal to identify the category of instrument image data to be acquired, the type of instrument panel image display apparatus used on the vehicle, and the type of vehicle mounted with the instrument panel image display apparatus. Then, based on these identified results, the server control section 81 generates a category identifier representing the category, a vehicle type identifier representing the type of vehicle, and an apparatus identifier representing the type of apparatus. After that, the server control section 81 generates an identifier signal representing these identifiers, and then outputs the signal to the instrument image data acquisition section 84.

In response to input of the identifier signal, the instrument image data acquisition section 84 accesses the image database 90 to acquire thumbnail data corresponding to the identifiers represented by the identifier signal. For example, first, the image database 90 determines, in accordance with the category identifier, a sub-database (various instrument image databases such as a high-speed speedometer image database. The same applies to the background image database) to be accessed. Next, the image database 90 accesses the sub-database thus determined and, in accordance with the apparatus identifier and the vehicle type identifier, acquires all the thumbnail data stored in the sub-database in such a form as to be associated with both of these identifiers. Then, the instrument image data acquisition section 84 outputs, to the server control section 81, the thumbnail data thus acquired.

In response to input of the thumbnail data, the server control section 81 outputs the thumbnail data to the server communication section 82. Then, in response to input of the thumbnail data, the server communication section 82 sends the thumbnail data to the communication section 66.

Upon receiving the thumbnail data, the communication section 66 outputs the thumbnail data to the image data change control section 61. Then, in response to input the thumbnail data, the image change control section 61 outputs the thumbnail data to the image display section 67, whereby the image display section 67 causes the instrument panel 52 to display thumbnails encoded by the thumbnail data. After that, the driver can select from among the thumbnails of selectable instrument images on the instrument panel 52 through the operation section 54.

At this point, the driver uses the operation section 54 to select any one of the thumbnails displayed on the instrument panel 52. Then, the operation section 54 outputs, to the image data change control section 61, an image identification signal representing the instrument image to which the driver changes.

In response to input of the image identification signal, the image data change control section 61 generates an instrument image data request signal containing the image identification signal, and then outputs the instrument image data request signal to the communication section 66. Then, the communication section 66 sends the instrument image data request signal to the server communication section 82.

Upon receiving the instrument image data request signal, the server communication section 82 outputs the signal to the server control section 81. Then, the server control section 81 analyzes the signal to generate, based on the image identification signal contained in the signal, an identifier signal representing an identifier corresponding to the instrument image data to be acquired. Then, the server control section 81 outputs the image identifier signal to the instrument image data acquisition section 84.

In response to input of the identifier signal, the instrument image data acquisition section 84 accesses the image database 90 to acquire, based on the identifier represented by the identifier signal thus inputted, a piece of instrument image data associated with the identifier. Then, the instrument image data acquisition section 84 outputs, to the server control section 81, the instrument image data thus acquired.

In response to input of the instrument image data, the server control section 81 outputs the instrument image data to the server communication section 82. Then, in response to input of the instrument image data, the server communication section 82 sends the instrument image data to the communication section 66.

Upon receiving the instrument image data, the communication section 66 outputs the instrument image data to the image data change control section 61. Then, in response to input of the instrument image data, the image data change control section 61 writes the instrument image data in the memory (not illustrated) and outputs the instrument image data to the image display section 67.

With use of the instrument image data inputted thereto, the image display section 67 updates the instrument image on the instrument panel 52. Specifically, the image display section 67 replaces the previously displayed instrument image with the instrument image encoded by the instrument image data inputted thereto, and causes the instrument panel 52 to display the latter instrument image. Therefore, the newer instrument image selected by the driver replaces the older instrument image to be displayed on the instrument panel 52. After that, as in the case of the instrument panel image display apparatus 1, the driver selects a category of image to which he/she would like to change, and a process by which the image thus selected is changed to suit the driver's own preferences within a range defined in advance is executed.

The aforementioned instrument panel image changing system 40 is merely an example, and may be a system of another configuration. For example, such a system can also be configured that the server 80 includes the regulating database 70.

In this case, a correction data acquisition section (not illustrated) is provided in the server 80 for acquiring correction data from the regulating database 70 contained in the server 80. Moreover, in the server 80, the correction data acquisition section acquires correction data from the regulating database 70 in accordance with a correction data request signal sent from the communication section 66. Then, the server 80 sends the data to the instrument panel image display apparatus 50 through the server communication section 82. Thus, in the instrument panel image display apparatus 50, the parameter correction section 65 corrects, with use of the parameter correction data acquired from the server 80, parameters contained in the instrument image data.

Further, such a system can also be configured that the server 80 also includes the parameter correction section 65. In this case, a parameter value defining the display state of an instrument image and an identifier signal identifying the type of instrument image whose display state is defined by the parameter are sent to the server 80. Then, on the side of the server 80, parameter correction data is acquired from the regulating database 70 with use of an identifier represented by the identifier signal, and the parameter value thus received is corrected. Then, the parameter value thus changed is sent to the instrument panel image display apparatus 50.

Upon receiving the parameter value, the instrument panel image display apparatus 50, e.g., the parameter adjustment section 64 uses the parameter value to change a parameter value to be corrected. Such a configuration also makes it possible to correct a parameter defining the display state of an instrument image.

Furthermore, such a system is also possible in which pre-correction instrument image data to be corrected is sent to the server 80 instead of a parameter value. In this system, a parameter is corrected in the server 80. Moreover, the server communication section 82 sends, to the instrument panel image display apparatus 50, instrument image data whose parameter has been corrected. The instrument panel image display apparatus 50 stores, in the memory, post-correction instrument image data thus received, and displays an instrument image according to the state of a vehicle.

Thus, in the instrument panel image changing system 40, the instrument panel image display apparatus 50 acquires instrument image data from the server 80. For this reason, even in cases where instrument image data encoding a selectable instrument image is newly provided, the data can be easily acquired. That is, even when data is updated on the server side or novel data is added, the new data can be made available promptly.

Further, in the instrument panel image changing apparatus 40, a range within which a parameter stored in a parameter-regulating table contained in the regulating database can vary can be updated as needed through the communication section. This makes it possible to create an instrument panel image in accordance with a change in stipulated value due to law amendment or the like.

It should be noted here that the aforementioned instrument panel image display apparatus 1 and instrument panel image changing apparatus 40 are merely preferred embodiments of the present invention. That is, as will be described below, the present invention can be applied in many variations within the scope of the claims.

For example, the data format of the aforementioned instrument image data may be any data format that encodes an image. That is, the data format of instrument image data and background image data may be a format such as: BMP (Bitmap) in which an image is stored in units of dots; a compressed data format such as TIFF (Tagged Image File Format), JPEG (Joint Progressive Experts Group), or PNG (Portable Network Graphics); or a vector data format such as EPS (Encapsulated PostScript) or PDF (Portable Document Format).

In cases where the data format of instrument image data and background image data is Bitmap, plural pieces of bitmap data representing instrument images and background images of different various sizes are prepared, and these images are changed to fit a size set by a driver, whereby the display state can be changed without deterioration in resolution of the images. Meanwhile, it is also possible to display instrument images and background images of various sizes by changing a single piece of bitmap data.

Further, the instrument image data and background image data may be data encoding a single still image, or may be data encoding a moving image composed of a plurality of still images. Alternatively, the instrument image data and background image data may be an image data group composed of plural pieces of instrument image data and background image data each encoding a single still image. For example, the state of a speedometer image displayed on the instrument panel is changed over time in accordance with changes in traveling speed of the vehicle. Therefore, instrument image data encoding the speedometer image may be an image data group composed of plural pieces of image data encoding still images representing the respective states of the traveling speed.

The aforementioned image databases 21 and 90 may be of any format as long as they are databases in which instrument image data, background image data, and thumbnail data can be stored. For example, instrument image data may be configured to be in an XML (Extensible Markup Language) and linked to background image data. This makes it possible that once a speedometer image is downloaded, a background image for use with a speedometer is downloaded simultaneously. Further, the regulating database 22 and 70 may be of any format as long they are databases in which correction parameter values and identifiers identifying the types of parameter to be corrected are stored in association with each other. That is, these databases can be hash databases or relational databases in which identifiers and data are stored in association with each other.

Further, the regulating databases 22 and 70 both have parameter-regulating tables stored therein for respective categories to which various types of instrument image data and background image data belong to. This makes it possible to reduce the size of these databases. However, these databases may have data-by-data parameter-regulating tables stored therein to correspond to every one of the various types of instrument image data and background image. In this case, as compared to the format in which the category-by-category parameter-regulating tables are stored, the display state of at least either an instrument image or a background image can be corrected more finely.

Further, these databases only need to be stored in a given nonvolatile storage medium (memory). It does not matter whether or not such a storage medium is detachable. Furthermore, it does not matter whether or not the storage medium is rewritable (writable), nor does it matter what recording method the storage medium employs and what shape the storage medium takes. Examples of such a storage medium include tapes, such as magnetic tapes and cassette tapes; magnetic disks, such as floppy (registered trademark) disks and hard disks; and other discs, such as CD-ROMs, magneto-optical discs (MOs), mini discs (MDs), and digital video discs (DVDs). In addition, the storage medium may be a card, such as an IC card or an optical card; or a semiconductor memory, such as a mask ROM, an EPROM, an EEPROM, or a flash ROM.

Further, in the regulating databases 22 and 70, the types of subtable that are stored in a parameter-regulating table are not limited to those subtables illustrated in FIG. 4. That is, in the regulating databases 22 and 70, a parameter-regulating table may contain subtables for correcting other parameters. For example, a parameter-regulating table may contain a subtable having stored therein correction values concerning the luminance or contrast of an instrument image, an allowable distance between one instrument image and another, or an allowable distance between one character and another in an instrument image.

Further, in changing candidate values for the parameters to values of the next candidate, the parameter correction section 16 and the parameter correction section 65 may change, to values of the next candidate, only some of the parameters that have been designated by a driver, for example, instead of changing, to values of the next candidate, all the parameters corresponding to all the instrument images. Furthermore, immediately after the parameter correction section 16 and the parameter correction section 65 change the parameters, the parameter correction section 16 and the parameter correction section 65 may automatically correct the parameters without waiting for correction instructions from the driver through the operation section 4.

Further, in the instrument panel image display apparatus 1, the instrument panel 2 (display panel) is a display panel for displaying image data. This instrument panel 2 is horizontally long with an aspect ratio of not less than 7:3, which indicates the ratio of width to height in display region. This improves the visibility of a simultaneous display of an additional image such as a navigation image and a vehicle state image indicating the state of a vehicle such speed and fuel. Further, the aspect ratio can be 8:3, 30:9, 32:9, or the like. For this reason, the instrument panel 2 can be prepared by combining two panels each having an aspect ratio of 4:3, 15:9, or 16:9. The instrument panel 2 of the present preferred embodiment is, but is not limited to, a wide-sized liquid crystal display panel. For example, the instrument panel 2 may take the form of an organic or inorganic EL (electroluminescence) panel, a plasma display panel, a CRT (cathode ray tube), or the like. The same applies to the instrument panel 52.

Further, the operation section 4 and the operation section 54 can employ an input method such as a touch panel, a hard key, a mouse, or a joystick. Here, in cases where the operation section 4 and the operation section 54 are realized by touch panels, the operation section 4 and the operation section 54 can be integrated into the instrument panel 2 and the instrument panel 52, respectively.

Further, a driver can correct the display state of an instrument image by directly changing the display state of the image on the screen and then changing the parameter values to values corresponding to the display state, as well as by directly inputting numerical values for the parameters. For example, the size of an image can be changed by a method for inputting the width (X) and height (Y) of an image separately, a method for input through operation of a slide bar, or a method for changing the size of an image on a screen by drag-and-drop. Alternatively, the size of an instrument image may be changed by displaying a “SCALE UP” button and a “SCALE DOWN” button on the screen and letting the driver press either of these buttons through the operation section 4.

Further, the parameters defining the display state of an instrument image and background image data may be collectively saved in a file different from a file of instrument image data and background image data. Furthermore, it is preferable that the parameters define at least the size and coloration of an instrument image and a background image. This makes it possible to change at least the size and coloration of an instrument image and a background image.

Further, in changing at least either an instrument image or a background image, the present invention may use a template file in which parameters defining the display state have been stored in advance by category of at least either the instrument image or the background image. In this case, the display state of at least either an instrument image or a background image selected by the driver is changed immediately after the selection on the basis of the parameter values recorded in the template file. This makes it possible to quickly complete the selection of at least either the instrument image or the background image.

Further, the instrument panel image display apparatus is mounted on a vehicle. The term “vehicle” in the present specification encompasses general land transportation equipment or apparatuses, such as automobiles, two-wheeled motor vehicles, and bicycles, which require driver's steering for movement. Further, the instrument panel image display apparatus 1 can be applied to any transportation equipment or apparatuses, such as helicopters, aircrafts, and ships, which require operator's maneuvering for movement, as well as to vehicles. Further, the instrument panel image display apparatus 1 can be widely applied to general machines including operation panels, as well as to transportation equipment or apparatuses.

Furthermore, the image data change control section 10 of the instrument panel image display apparatus 1 and the image data change control section 60 of the instrument panel image display apparatus 50 may be stored in a terminal of a shop that sells transportation equipment or apparatuses such as vehicle. In this case, various instrument panel images created by operating the terminal are sent to transportation equipment or apparatuses through a network line, and then stored in a memory mounted on the transportation equipment or apparatuses. Then, an instrument panel image according to the state of the transportation equipment or apparatuses is displayed.

Specifically, various instrument panel images are stored a memory that is mounted on a vehicle, and an instrument panel image according to results of detection of the shift range (state of a gear), the number of revolutions of the tachometer, the traveling speed, and the like by a detection section that detects an operation condition of the vehicle is displayed. Further, an instrument panel image according to results of detection by a temperature sensor, a light-receiving sensor, and the like that detect an environment surrounding the vehicle.

Further, the communication section 66 and the server communication section 82 communicate with each other according to any communication method as long as the communication method is a wireless transfer method. Examples of such a wireless transfer method include infrared radiation (IrDA, remote control), Bluetooth (registered trademark), 802.11 wireless, HDR, mobile telephone network, satellite line, or terrestrial digital network. Furthermore, in these communications, data and signals may be transmitted and received in compressed forms.

Each of the members thus described is a functional block. Therefore, these members may preferably be realized by computing devices such as a CPU executing an instrument panel image display program stored in a memory section (not illustrated) and controlling a peripheral circuit (not illustrated) such as an input-output circuit.

Therefore, preferred embodiments of the present invention can also be achieved by mounting to the instrument panel image display apparatus a computer-readable storage medium containing control program code (executable program, intermediate code program, or source program) for the instrument panel image display program, which is software realizing the aforementioned functions, in order for the computer (or CPU, MPU, DSP) to retrieve and execute the program code contained in the storage medium.

In this case, the program code retrieved from the storage medium realizes the aforementioned functions, and storage medium containing the program code constitutes a preferred embodiment of the present invention. Specifically, the image data changing section 10 of the instrument panel image display apparatus 1 and the image data changing section 60 of the instrument panel image display apparatus 50 are each realized by computing devices such as a microprocessor executing a predetermined program stored in a memory (not illustrated) of the instrument panel image display apparatus.

Meanwhile, the aforementioned members may each by realized as hardware that executes the same process as the aforementioned software. In this case, a preferred embodiment of the present invention is realized in a instrument panel image display apparatus, which is hardware.

Further, the computing devices may be constituted by single computing device. Alternatively, the computing devices may be constituted by a plurality of computing devices, connected through buses inside of the apparatus or various communication paths, which cooperate to execute the program code.

It should be noted here that the program code that can be executed directly by the computing devices or the program, serving as data, whose program code can be generated by a process such as decompression to be described later is executed by the computing device storing the program or data in a storage medium and distributing the storage medium or transmitting the program over a communication network for transmission through a wired or wireless communication path.

The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium (communication path) which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth, 802.11 wireless, HDR, mobile telephone network, satellite line, or terrestrial digital network.

Here, the storage medium for the distribution of a program is preferably removable. After the distribution of the program, the storage medium may or may not be removable. In addition, the storage medium may or may not be rewritable (writable) or volatile, be recordable by any method, and come in any shape at all, provided that the medium can hold the instrument panel image display program.

Examples of such a storage medium include tapes, such as magnetic tapes and cassette tapes; magnetic disks, such as floppy (registered trademark) disks and hard disks; and other discs, such as CD-ROMs, magneto-optical discs (MOs), mini discs (MDs), and digital video discs (DVDs). In addition, the storage medium may be a card, such as an IC card or an optical card; a semiconductor memory, such as a mask ROM, an EPROM, an EEPROM, or a flash ROM; or a memory provided inside a CPU or other computing devices.

It should be noted that a program for retrieving the program code from the storage medium and storing it in a main memory and a program for downloading the program code from the communication network are stored in advance in the apparatus in such a way as to be able to be executed by a computer.

The program code may be such that it instructs the computing devices regarding all the procedures of the processes. If there is already a basic computer program (for example, an operating system or library) which can be retrieved by a predetermined procedure to execute all or some of the processes, code or a pointer which instructs the computing devices to retrieve that basic computer program can replace all or some of the processes.

In addition, the instrument panel image display program storage format of the storage medium may be, for example, such that the computing devices can access the program for an execution as in an actual memory having loaded the program; the program is not loaded into an actual memory, but installed in a local storage medium (for example, an actual memory or hard disk) always accessible to the computing devices; or the program is stored before installing in a local storage medium from a network or a mobile storage medium.

In addition, the instrument panel image display program is not limited to compiled object code. The program may be stored as source code or intermediate code generated in the course of interpretation or compilation.

In any case, similar effects are obtained regardless of the format in which the storage medium stores the instrument panel image display program, provided that decompression of compressed information, decoding of encoded information, interpretation, compilation, links, or loading to an memory or combinations of these processes can convert into a format executable by the computing devices.

The present invention is not limited to the description of the preferred embodiments above, but may be altered by a skilled person within the scope of the claims. A preferred embodiment based on a proper combination of technical features disclosed in different preferred embodiments is encompassed in the technical scope of the present invention.

As described above, in an instrument panel image display apparatus according to a preferred embodiment of the present invention, a display state of an instrument image contained in an instrument panel mage is changed to another display state according to a state of the machine, the another display state being selected from among a plurality of display states determined in advance according to the state of the machine. Therefore, the instrument panel image display apparatus according to a preferred embodiment of the present invention brings about an effect of making it possible to create an instrument panel image according to the user's own preferences and the state of the machine without undermining safety during operation.

The preferred embodiments and specific examples of implementation discussed in the foregoing detailed explanation serve solely to illustrate the technical details of the present invention, which should not be narrowly interpreted within the limits of such preferred embodiments and specific examples, but rather may be applied in many variations within the spirit of the present invention, provided such variations do not exceed the scope of the patent claims set forth below.

The present invention can be applied to an image display apparatus capable of changing a display screen design that is mounted on transportation equipment and apparatuses such as an automobile including an instrument panel or a general machine such as a control machine including an operation panel.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-14. (canceled)

15. An instrument panel image display apparatus for displaying an instrument panel image on an instrument panel mounted on a machine, the instrument panel image display apparatus comprising:
a display section arranged to display, in accordance with image data encoding instrument images that provide a user with information about inside and outside of the machine, an instrument panel image containing the instrument images; and
an image data changing section arranged to change a display state of an instrument image to another display state according to a state of the machine, said another display state being selected from among a plurality of display states determined in advance according to the state of the machine.

16. The instrument panel image display apparatus as set forth in claim 15, further comprising a parameter changing section arranged to change a parameter from one value to another, the parameter defining the display state of the instrument image.

17. The instrument panel image display apparatus as set forth in claim 16, further comprising a parameter judging section arranged to judge whether or not the parameter is taking on a value falling within a predetermined range.

18. The instrument panel image display apparatus as set forth in claim 17, wherein when the parameter judging section judges that the parameter as entered by an outside is not taking on a value falling within the predetermined range, the instrument panel image display apparatus prompts the outside to reenter the parameter.

19. The instrument panel image display apparatus as set forth in claim 17, wherein when the parameter judging section judges that the parameter is not taking on a value falling within the predetermined range, the parameter changing section changes the parameter to a value falling within the predetermined range.

20. The instrument panel image display apparatus as set forth in claim 16, wherein the parameter defines at least a size and a coloration of the instrument image.

21. The instrument panel image display apparatus as set forth in claim 20, wherein the parameter further defines a position of the instrument image.

22. The instrument panel image display apparatus as set forth in claim 15, further comprising an image data acquisition section arranged to acquire, through a network line from a server including a storage section, image data encoding the instrument image whose display state has been changed to said another display state, the storage section having the image data stored therein.

23. A server that provides an instrument panel image display apparatus as set forth in claim 22 with image data encoding the instrument image whose display state has been changed to said another display state.

24. An instrument panel image changing system comprising:
an instrument panel image display apparatus as set forth in claim 22; and
a server arranged to provide the instrument panel image display apparatus with image data encoding the instrument image whose display state has been changed to said another display state.

25. A vehicle comprising an instrument panel image display apparatus as set forth in claim 15.

26. An instrument panel image changing method for displaying an instrument panel image on an instrument panel mounted on a machine, comprising the steps of:
(i) displaying, in accordance with image data encoding instrument images that provide a user with information about inside and outside of the machine, an instrument panel image containing the instrument images; and
(ii) changing a display state of an instrument image to another display state according to a state of the machine, said another display state being selected from among a plurality of display states determined in advance according to the state of the machine.

27. A tangible computer-readable storage medium containing an instrument panel image display computer program with program code for executing, when the computer program runs on a computer, the steps of the method according to claim 26.
